(19) United States
(12) Patent Application Publication
(10) Pub. No.: US 2019/0260276 A1
(43) Pub. Date: Aug. 22, 2019

(54) WAVE WINDING DEVICE AND METHOD FOR PRODUCING A WAVE WINDING

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/261,663

(22) Filed: Jan. 30, 2019

(30) Foreign Application Priority Data
Feb. 21, 2018 (EP) 18157806.3

(51) Int. Cl. H02K 15/04; B21F 3/02

(52) U.S. Cl. CPC H02K 15/0478; B21F 3/02

(57) ABSTRACT

A wave winding device includes a wire outlet nozzle arrangement through which a winding wire or a plurality of winding wires is fed. It further includes a shaping core at least rotatably displaceable relative to the wire outlet nozzle arrangement, on which the winding wire or the winding wires is or are windable. The wave winding device further includes a bending aid deliverable to the winding wire, which is designed to bend a section of a winding wire fed from the wire outlet nozzle arrangement before the section is placed on the shaping core.

### CROSS REFERENCE TO RELATED APPLICATIONS

This application claims priority on and the benefit of European Patent Application No. 18 157 806.3 having a filing date of 21 Feb. 2018.

### BACKGROUND OF THE INVENTION

### Technical Field

The invention relates to a wave winding device, including a wire outlet nozzle arrangement through which a winding wire or a plurality of winding wires is fed, and including a shaping core at least rotatably displaceable relative to the wire outlet nozzle arrangement, on which the winding wire or the winding wires is or are windable, and to a method for producing a wave winding, in which a winding wire or a plurality of winding wires is fed from a wire outlet nozzle arrangement to a shaping core and wound on the shaping core by rotating the shaping core, wherein i) the fed winding wire is placed on and held fast to the shaping core; ii) the shaping core is then rotated by 180°.

### Prior Art

The wave winding is used, among other things, for winding stator cores and rotor cores. One or a plurality of wave-like windings are designed to form a winding mat, as disclosed, for example, in DE 199 22 794 B4, DE 10 2004 035 084 A1 or DE 10 2008 021 779 A1. In the process, the wire or wires is/are wound around a shaping core and formed in the desired shape. These winding mats are inserted in a subsequent step into the corresponding grooves of the stator or rotor. The cross sections of the wound lines are generally round or rectangular.

A central feature in the design of such wave windings is the design of the winding heads. These must be designed in the winding mats so that when introduced into grooves of a stator or rotor, wherein the winding mats are ultimately rolled up, the winding heads do not impede one another or assume a technically disadvantageous shape or position. For this reason, the bending of the wire during production of the wave winding plays a central role. DE 600 18 369 T2 discloses reducing a material weakness during bending by twisting the wire at the bending point. The drawback associated with this is a bending point that requires greater space.

However, it has proven advantageous to also wind line bundles, which have a rectangular cross section. In this case, as disclosed by DE 10 2008 019 479 A9, the bending takes place via the wide side while simultaneously turning the wire by 180°, since the wire, when bending the flat wire via the narrow side, would yield when twisted. A bending in this manner occupies a certain volume, because the wide side also rotates by 180°. Because of the space requirement, it is difficult, especially in a compact construction, to arrange adjacent bends on the circumference of a stator. This requires offsetting, and with that, greater space requirement.

When creating a wave winding according to the conventional method (FIG. 11), 2 wires are wound around a shaping core. Here, a single-step reshaping process takes place with simultaneous bending (arrow P3) and setting (arrows P1 and P2) in the area of the winding head 2a. A flat, triangular winding head 2a is the result. Such an approach may potentially also take up a comparatively large amount of space.

The approach disclosed in DE 10 2014 110 377 A1 is even more space-saving. In this so-called hairpin technology, the windings are not produced as a mat, rather, individual windings are situated so that the matching ends are next to one another and are subsequently connected to each other. A winding head produced by means of hairpin technology (cf. FIG. 12) is not flat as above, but helical. Such a winding head in the product proves to be compact and advantageous with respect to the winding transitions, in particular, when using upright flat wires. This shape is the result of a two-stage reshaping process. The straight wire 2 is bent initially into a U-shape (P3) and subsequently, i.e. at a later point in time, set (P1 and P2). During bending a strain hardening occurs, which lends the winding head the particular helical wire shape when it is subsequently set. Such an arrangement saves space in the circumferential direction of the stator or rotor, but this production method requires significant effort to produce the connections.

### BRIEF SUMMARY OF THE INVENTION

The object of the invention is to provide a winding device and a method for producing a wave winding, which enables a cost-effective and space-saving bending, in particular, of a flat wire.

This object is achieved by a winding device, including a wire outlet nozzle arrangement through which a winding wire or a plurality of winding wires is fed, and including a shaping core at least rotatably displaceable relative to the wire outlet nozzle arrangement, on which the winding wire or the winding wires is or are windable, characterized in that the wave winding device further includes a bending aid deliverable to the winding wire, which is designed to bend a section of a winding wire fed from the wire outlet nozzle arrangement before the section is placed on the shaping core, and by a method for producing a wave winding, in which a winding wire or a plurality of winding wires is fed from a wire outlet nozzle arrangement to a shaping core and wound on the shaping core by rotating the shaping core, wherein i) the fed winding wire is placed on and held fast to the shaping core; ii) the shaping core is then rotated by 180°; characterized in that between step i) and step ii), a bending aid is delivered to the fed winding wire in a step ia), so that the winding wire is held by the bending aid.

The subject matter of the invention is a wave winding device, including a wire outlet nozzle arrangement, through which a winding wire or a plurality of winding wires is fed, and including a shaping core at least rotatably displaceable relative to the wire outlet nozzle arrangement, on which the winding wire or the winding wires is or are windable, wherein the wave winding device further includes a bending aid deliverable to the winding wire, which is designed to bend a section of the winding wire fed from the wire outlet nozzle arrangement before the section is placed on the shaping core. This bending aid serves to guide the wire during bending and prevents the wire from twisting as it is bent, specifically, when it is bent via the narrow side. Thus, the flat wire may be wound in a space-saving manner via the narrow side in a wave winding, without the need to subsequently create connections of wire sections. With a wave winding device according to the invention, it is possible to preliminarily reshape shaped wires for finished shaping on a shaping core, i.e. before placement on the shaping core.

According to one advantageous embodiment of the present invention, the bending aid has a comb-like shape. The comb-like shape makes it possible to accommodate the wire, in each case, between two teeth or projections of the comb and to thus bend multiple wires at the same time, thereby also allowing multiple wires to be processed at the same time.

In one particularly advantageous embodiment, the winding wire is a flat wire and the comb-like shape of the bending aid includes intermediate spaces, the width of which are dimensioned so that they are greater than the narrow sides of the flat wire but smaller than the wide side of the flat wire. In this way, a flat wire may be easily introduced with the narrow side into the intermediate space of the comb, wherein the narrow dimensioned intermediate space between the teeth or projections prevents the wire from being able to twist during bending. Torsion forces occur, especially in the case of flat wires that are intended to be bent via the narrow side, since the wire seeks to yield to a greater material expansion as a result.

According to one especially particularly preferred embodiment, the bending aid is deliverable in a direction parallel to the feed direction. Since the bending aid is invariably needed only if the bend of the wire exceeds a minimum angle, it is advantageous if the bending aid is delivered only when the minimum angle is exceeded. As a result, the wire outlet nozzle arrangement may be guided very closely to the shaping core and thereby enhance the winding precision.

The invention further relates to a method for producing a wave winding, in which a winding wire or a plurality of winding wires is fed by a wire outlet nozzle arrangement to a shaping core and wound on the shaping core by rotating the latter, wherein

i) the fed winding wire is placed on the shaping core and held fast to the latter,
ii) the shaping core is then rotated by 180°,
wherein between step i) and step ii) a bending aid is delivered to the fed winding wire in a step ia), so that the winding wire is held, in particular, in an upright position by the bending aid. As a result of the bend at the bending aid, the winding wire is bent before it is placed on the shaping core.

The winding wire, if it is designed as flat wire, may be held in an upright position by the bending aid. By including the bending aid, the wire is held in such a way that it is unable to yield via the narrow side during bending by twisting. The winding wire, once it is bent via the bending aid, is placed on the shaping core by the rotation of the latter.

In one preferred method, the bending aid in a step iia) is withdrawn from engagement with the winding wire during step ii), in particular, for example, after a 90° rotation of the shaping core. If the bending process has progressed to the point that the yielding movement of the wire during further bending is negligible, the bending aid is withdrawn again, so that the wire outlet nozzle arrangement may again be guided close to the shaping core.

In one particularly preferred method, steps i) and ii), in particular, i), ia), ii), iia), are carried out repeatedly. The wave winding may thus be created in one continuous process, wherein, as the wire is bent via the narrow side, the bending aid prevents the wire from being able to yield to the bending by twisting.

Such a method makes it possible to manufacture a stator winding or a rotor winding with a flat wire in a space-saving and cost-effective manner.

### BRIEF DESCRIPTION OF THE DRAWINGS

The invention is explained in greater detail below with reference to the FIGS. 1 through 13.

FIG. 1 shows a detail, in which a shaping core is wound with winding wire,

FIG. 2 shows a wire outlet nozzle arrangement having winding wires and a deliverable bending aid,

FIG. 3 schematically shows a part of a stator core or a rotor core, in which a winding is inserted into the grooves,

FIGS. 4 through 10 show a sequence of winding steps,

FIG. 11 shows the production of a winding head based on the prior art,

FIG. 12 shows the production of a winding head based on the hairpin technology, and

FIG. 13 shows the production of a winding head based on the method according to the invention.

### DETAILED DESCRIPTION OF PREFERRED EMBODIMENTS

FIG. 1 shows a shaping core 4, which is in the process of being wound. The winding wires 2 are guided through the comb-like ends 3a of the bending aid 3 and have been placed on the flat side of the shaping core 4. The winding wires 2 are held on the shaping core 4 by means of wire holder elements 6. The wire holder elements 6 are preferably gripper jaws, which grasp the winding wire 2 and press it against the shaping core 4.

The bent sections 2a of the winding wire are shown at the lower end of the shaping core 4. The situation shown is chronologically shortly before the shaping core 4 starts to rotate about the center axis, which is situated in the drawing plane. As the rotation starts, the winding wires 2 are guided through the comb-like ends 3a of the bending aid 3 in order to prevent the winding wire 2 from twisting during bending. The wire holder elements 6 are subsequently moved on the shaping core 4 in a direction transverse to the orientation of the winding wire, in order to achieve a predefined offset of the winding wire 2, a setting, during bending. In the process, the winding wire 2 drops onto the blade due to the radial shortening in the projection and the installation space used by the bending aid 3 is no longer present. The winding process is explained in greater detail below with reference to the FIGS. 4 through 10.

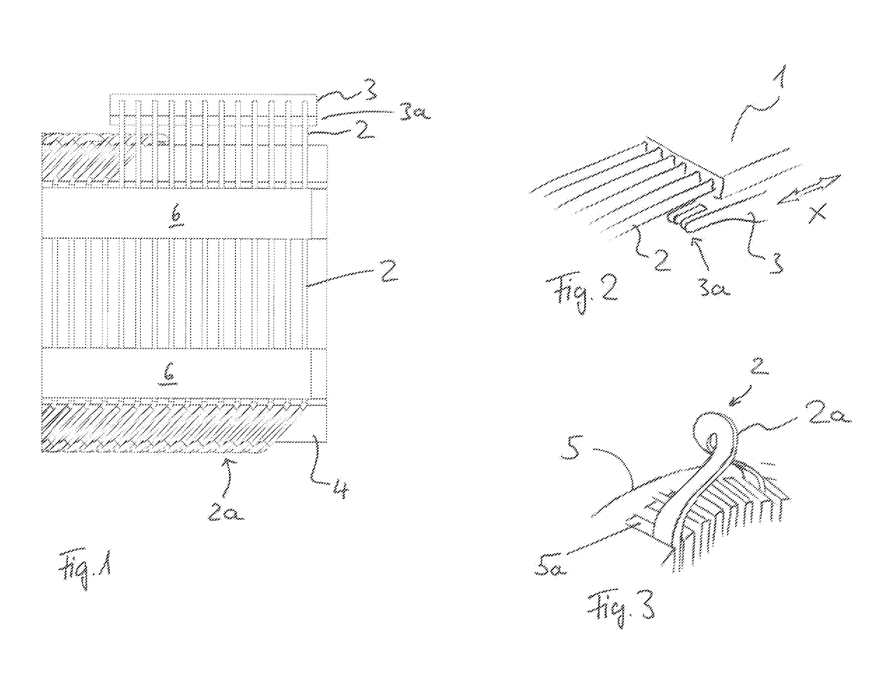

FIG. 2 shows a wire outlet nozzle arrangement 1, from which multiple winding wires 2 exit. The bending aid 3, which may be moved in the X-direction relative to the wire outlet nozzle arrangement 1, is situated in the area of the outlet nozzles (below the latter in the example shown). The situation shows the bending aid 3 with the comb-like ends 3a in a partially extended state. The intermediate spaces between the teeth or projections of the comb-like end 3a are wider than the narrow side of the winding wire 2, so that the winding wire is able to drop into the intermediate spaces of the comb in the upright position. At the same time, the intermediate space is significantly narrower than the wide side of the flat winding wire 2, so that the bending aid thus designed prevents the winding wire 2 from being able to twist during bending and thus from yielding via the narrow side.

FIG. 3 shows a detail of a stator core or rotor core 5, in which a flat wire 2 consisting of a flat material is inserted into the grooves 5a. The winding wire 2 is bent in the direction of the narrow side toward a winding head 2a and is therefore not protracted in the direction of the circumference of the stator or the rotor. Such a design allows for a very compact construction of the stator or rotor.

FIG. 4 shows the initial situation of a winding. The smallest thickness of the shaping core 4 points upwardly. The winding wires are placed on the upper side and are held by the wire holder elements 6. The winding wires 2 exit from the wire outlet opening arrangement 1. The bending aid 3, which in a non-use situation is located below the wire outlet nozzle arrangement, is above (below would also be conceivable) the wire outlet nozzle arrangement 1. The two sections 2a of the winding wire 2, which exhibit a distinct curvature and originate from a preceding winding cycle, are shown at the left and right ends of the shaping core 4.

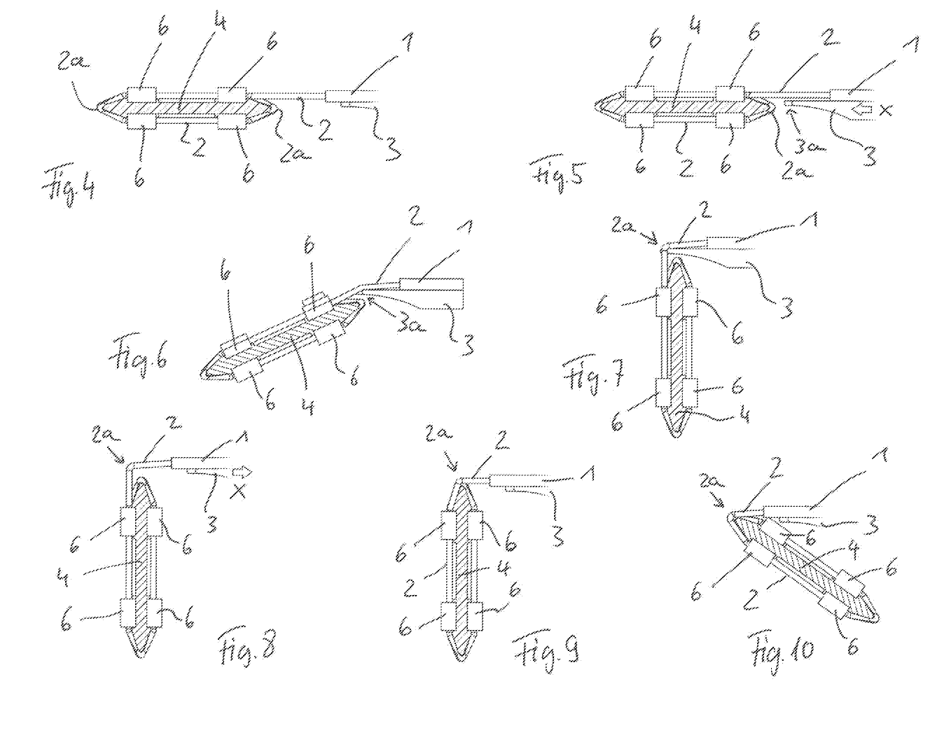

In FIG. 5, the bending aid 3 is delivered to the comb-like end 3a by having been moved in the arrow direction X from the non-use position. In FIG. 6, the shaping core 4 begins to rotate, wherein the winding wires 2 are guided into the comb-like ends 3a of the bending aid 3. In FIG. 7, the shaping core 4 has been rotated by 90°, and the winding wire 2 has been bent by 90° at the section 2a, wherein the winding wire 2 at that point is guided through and held at the comb-like end 3a of the bending aid 3. In this situation, the winding wire 2 is above the tip of the shaping core 4. This corresponds to the situation depicted in FIG. 1. The bending aid 3 is subsequently returned again to the non-use position below the wire outlet nozzle arrangement 1, as shown in FIG. 8.

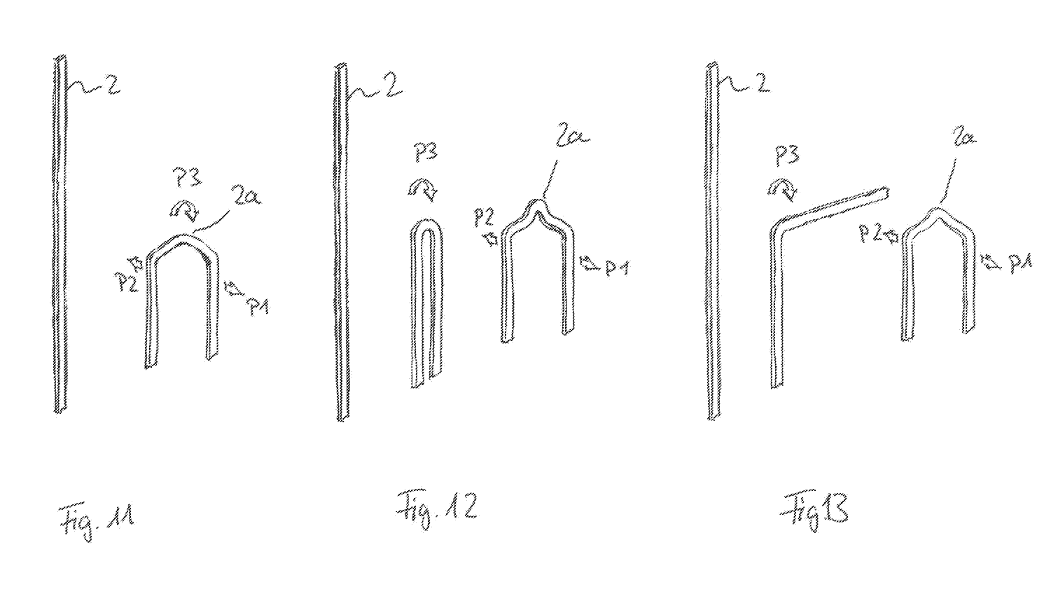

In the next step, the placed winding wires 2 are pulled in by means of the wire holder elements 6 in the drawing plane, as a result of which the winding wires 2 are interlocked and the winding heads 2a of the winding wires 2 produced by the bending end up on the narrow side of the shaping core 4, as is shown in FIG. 9. This produces, as when a prefabricated U-hairpin is set (compare FIG. 12), a different shape of the wire transition in the winding head optimized for the compactness of the winding head 2a.

Finally, as shown in FIG. 10, the shaping core 4 is rotated further until a 180° rotation is completed. The newly wound winding wires 2, which are supported on top of the shaping core 4, are grasped and held in place by the wire holder elements 6. The next winding cycle according to FIGS. 4 through 10 may then be repeated.

In addition, the inclusion of the bending aid 3 with its comb-like end 3a prevents the winding wire 2, especially during the bending process, from yielding to the bending movement via the narrow side by twisting during the bending. With such a bending aid 3, it is possible to reliably shape a narrow flat wire 2 via the narrow side to form a wave winding and to thus integrate it in a stator core or a rotor core 5 in a cost-effective and space-saving manner.

The reshaping process according to the invention is schematically shown once again in FIG. 13. During the creation of a wave winding, an integrated pre-bending process and a subsequent setting process are carried out by means of the bending aid 3. This involves a two-stage reshaping process: The winding wire 2 is initially bent for placement on the shaping core (P3) and after subsequent placement on the shaping core, the setting (P1, P2) is carried out, in which the two straight sections of the wire are pulled apart relative to one another in the direction of the arrows B1, respectively PII. In this way, it is also possible to produce winding heads 2a which, as in the hairpin technology (cf. FIG. 12), are more helical and may be very compactly designed in the product produced with the wave windings. In the particular case described herein in which upright wound flat wire is used (other wire geometries are also conceivable), the comb shape of the bending aid also prevents the flat wire from tipping out during bending and a stable uniform winding pattern is produced.

1. A wave winding device, including a wire outlet nozzle arrangement (1) through which a winding wire (2) or a plurality of winding wires (2) is fed, and including a shaping core (4) at least rotatably displaceable relative to the wire outlet nozzle arrangement (1), on which the winding wire (2) or the winding wires (2) is or are windable, wherein
the wave winding device further comprises a bending aid (3, 3a) deliverable to the winding wire (2), the bending aid (3, 3a) being designed to bend a section (2a) of a winding wire (2) fed from the wire outlet nozzle arrangement (1) before the section (2a) is placed on the shaping core (4).

2. The wave winding device according to claim 1,
wherein the bending aid (3) has a comb-like shape.

3. The wave winding device according to claim 2, wherein
the winding wire (2) is a flat wire and the comb-like shape of the bending aid (3) includes intermediate spaces, the width of which is dimensioned such that it is greater than the narrow side of the flat wire (2) but smaller than the wide side of the flat wire (2).

4. The wave winding device according to claim 1, wherein the bending aid (3, 3a) is deliverable in a direction parallel to the feed direction of the winding wire (2).

5. A method for producing a wave winding, in which a winding wire (2) or a plurality of winding wires (2) is fed from a wire outlet nozzle arrangement (1) to a shaping core (4) and wound on the shaping core by rotating the shaping core (4), wherein i) the fed winding wire (2) is placed on and held fast to the shaping core (4); ii) the shaping core (4) is then rotated by 180°; comprising:
between step i) and step ii), delivering a bending aid (3) to the fed winding wire (2) in a step ia), so that the winding wire (2) is held by the bending aid (3).

6. The method according to claim 5,
wherein the winding wire (2) used is a flat wire, which is held in an upright position by the bending aid (3).

7. The method according to claim 5, wherein
during step ii), in particular, for example, after a 90° rotation of the shaping core (4), the bending aid (3) is withdrawn from engagement with the winding wire (2) in a step iia).

8. The method according to claim 7, wherein
steps i) and ii), in particular, i), ia), ii), iia) are carried out repeatedly.
